(19) United States
(12) Patent Application Publication
(10) Pub. No.: US 2024/0136111 A1
(43) Pub. Date: Apr. 25, 2024

(54) COIL COMPONENT

(71) Applicant: SAMSUNG ELECTRO-MECHANICS CO., LTD., Suwon-si (KR)

(72) Inventors: Tae Hyun KIM, Suwon-si (KR); Dong Hwan LEE, Suwon-si (KR); Dong Jin LEE, Suwon-si (KR); Byeong Cheol MOON, Suwon-si (KR); Boum Seock KIM, Suwon-si (KR)

(73) Assignee: SAMSUNG ELECTRO-MECHANICS CO., LTD., Suwon-si (KR)

(21) Appl. No.: 18/242,092

(22) Filed: Sep. 4, 2023

(30) Foreign Application Priority Data
Oct. 20, 2022 (KR) 10-2022-0136492

(51) Int. Cl. H01F 27/29; H01F 17/00

(52) U.S. Cl. CPC H01F 27/292; H01F 17/0013; H01F 2017/0066

(57) ABSTRACT

A coil component includes a body, a supporting member disposed in the body and including one surface and the other surface opposing the one surface in a first direction, a first coil including a first winding portion disposed on one surface of the supporting member, a second coil including a second winding portion disposed on the other surface of the supporting member, a first external electrode and a second external electrode connected to one end and the other end of the first coil, respectively, a third external electrode and a fourth external electrode connected to one end and the other end of the second coil, respectively, and a first connection electrode and a second connection electrode disposed on the other surface side of the supporting member and connecting one end and the other end of the first coil to the first and second external electrodes, respectively.

### CROSS-REFERENCE TO RELATED APPLICATION(S)

This application claims benefit of priority to Korean Patent Application No. 10-2022-0136492 filed on Oct. 21, 2022 in the Korean Intellectual Property Office, the disclosure of which is incorporated herein by reference in its entirety.

### TECHNICAL FIELD

The present disclosure relates to a coil component having an inductor array structure.

Along with the miniaturization and thinning of electronic devices such as digital TVs, mobile phones, laptops, etc., coil parts applied to these electronic devices are also required to be miniaturized and thin. To meet these demands, research and development of various types of winding type or thin film type coil parts are being actively conducted.

A major issue due to the miniaturization and thinning of coil parts is to implement characteristics equivalent to those of the existing coil parts despite such miniaturization and thinning. To satisfy these requirements, the proportion of magnetic material in the core filled with magnetic material should be increased, but there is a limit to increasing the ratio, for reasons such as the strength of the inductor body and a change in frequency characteristics due to insulation, and the like.

On the other hand, there is increasing demand for array-type components having the advantage of reducing the mounting area of coil parts. The array type coil part may have a noncoupled or coupled inductor type or a mixture of the above types according to a coupling coefficient or mutual inductance between the plurality of coil units.

### SUMMARY

An aspect of the present disclosure is to implement a coil component having an array structure, advantageous in miniaturization and in which a coupling coefficient between coils may be effectively controlled.

According to an aspect of the present disclosure, a novel structure of a coil component is proposed through an example. The coil component includes a body, a supporting member disposed in the body and including one surface and the other surface opposing the one surface in a first direction, a first coil including a first winding portion disposed on the one surface of the supporting member, a second coil including a second winding portion disposed on the other surface of the supporting member, a first external electrode and a second external electrode connected to one end and the other end of the first coil, respectively, a third external electrode and a fourth external electrode connected to one end and the other end of the second coil, respectively, and a first connection electrode and a second connection electrode disposed on the other surface of the supporting member and connecting one end and the other end of the first coil to the first and second external electrodes, respectively.

The first and second winding portions may have a single-layer structure.

At least portions of a core of the first winding portion and a core of the second winding portion may overlap in the first direction.

The first connection electrode may be disposed outside of the second winding portion, and the second connection electrode may be disposed inside of the second winding portion.

The coil component may further include a third connection electrode and a fourth connection electrode disposed on the other surface of the supporting member and connecting one end and the other end of the second coil to the third and fourth external electrodes, respectively.

The third connection electrode may be disposed outside of the first winding portion, and the fourth connection electrode may be disposed inside of the first winding portion.

The body may include a first surface and a second surface opposing in the first direction and disposed on the one surface and the other surface of the supporting member, respectively, and the first to fourth external electrodes may be disposed on the second surface.

The first and second external electrodes may be disposed on different corners of the second surface, respectively, the first external electrode and the fourth external electrode may face each other in a diagonal direction of the second surface, and the second external electrode and the third external electrode may face each other in the diagonal direction of the second surface.

The one end of the first coil may be an end of an outermost turn of the first winding portion, the other end of the first coil may be an end of an innermost turn of the first winding portion, the one end of the second coil may be an end of an outermost turn of the second winding portion, and the other end of the second coil may be an end of an innermost turn of the second winding portion.

The one end and the other end of the first coil may not be exposed to a side surface connected to the first and second surfaces in the body, and the one end and the other end of the second coil may not be exposed to a side surface connected to the first and second surfaces in the body.

The one end and the other end of the first coil may extend to the other surface of the supporting member, and a thickness of a region extending from each of the one end and the other end of the first coil to the other surface of the supporting member may be the same as a thickness of the second coil.

The first and second coils may not be electrically connected to each other within the coil component.

The supporting member may include a magnetic material.

According to an aspect of the present disclosure, a coil component includes a body, a supporting member disposed in the body and including one surface and the other surface opposing the one surface in a first direction, a first coil including a first winding portion disposed on the one surface of the supporting member, a second coil including a second winding portion disposed on the other surface of the supporting member, a first external electrode and a second external electrode connected to one end and the other end of the first coil, respectively, a third external electrode and a fourth external electrode connected to one end and the other end of the second coil, respectively, a first bypass electrode connecting the other end of the first coil to the second external electrode, and a second bypass electrode connecting the other end of the second coil to the fourth external electrode. The one end of the first coil is an end of an outermost turn of the first winding portion, and the other end of the first coil is an end of an innermost turn of the first winding portion, and the one end of the second coil is an end of an outermost turn of the second winding portion, and the other end of the second coil is an end of an innermost turn of the second winding portion.

At least portions of the first and second bypass electrodes may respectively overlap the first and second winding portions in the first direction.

At least portions of the first and second bypass electrodes may be buried in the supporting member.

The supporting member may include a magnetic layer and an insulating layer disposed on one surface and the other surface of the magnetic layer.

The first coil may be disposed between the first bypass electrode and the supporting member, and the second coil may be disposed between the second bypass electrode and the supporting member.

The first and second bypass electrodes may respectively include a bent portion.

According to an aspect of the present disclosure, a novel structure of a coil component is proposed through an example. The coil component includes a body, a supporting member disposed in the body and including one surface and the other surface opposing the one surface in a first direction, a first coil including a first winding portion disposed on the one surface of the supporting member, where the first winding portion has a single-layer structure, a second coil including a second winding portion disposed on the other surface of the supporting member, a first external electrode and a second external electrode connected to one end and the other end of the first coil, respectively, a third external electrode and a fourth external electrode connected to one end and the other end of the second coil, respectively, and a first connection electrode and a second connection electrode disposed on the other surface of the supporting member and connecting one end and the other end of the first coil to the first and second external electrodes, respectively. The first connection electrode may be disposed outside of the second winding portion, and the second connection electrode may be disposed inside of the second winding portion.

The coil component may further include a third connection electrode and a fourth connection electrode disposed on the other surface of the supporting member and connecting one end and the other end of the second coil to the third and fourth external electrodes, respectively.

The third connection electrode may be disposed outside of the first winding portion, and the fourth connection electrode may be disposed inside of the first winding portion.

The body may include a first surface and a second surface opposing in the first direction and disposed on the one surface and the other surface of the supporting member, respectively, and the first to fourth external electrodes may be disposed on the second surface.

### BRIEF DESCRIPTION OF DRAWINGS

The above and other aspects, features, and advantages of the present disclosure will be more clearly understood from the following detailed description, taken in conjunction with the accompanying drawings, in which:

FIGS. 1 and 2 are perspective views schematically illustrating a coil component according to an embodiment;

FIGS. 3 and 4 are plan views of main components of the coil component of FIG. 1 viewed from above;

FIGS. 5 to 8 are cross-sectional views of regions indicated in FIG. 1;

FIGS. 9 to 14 illustrate coil components according to modified examples; and

FIGS. 15 to 19 illustrate coil components according to other embodiments.

### DETAILED DESCRIPTION

Hereinafter, embodiments will be described with reference to detailed embodiments and accompanying drawings. However, the embodiments of the present disclosure may be modified in many different forms, and the scope of the present disclosure is not limited to the embodiments described below. In addition, the embodiments of the present disclosure are provided to more completely describe the present disclosure to those skilled in the art. Therefore, the shape and size of elements in the drawings may be exaggerated for clearer explanation, and elements indicated by the same reference numerals in the drawings are the same elements.

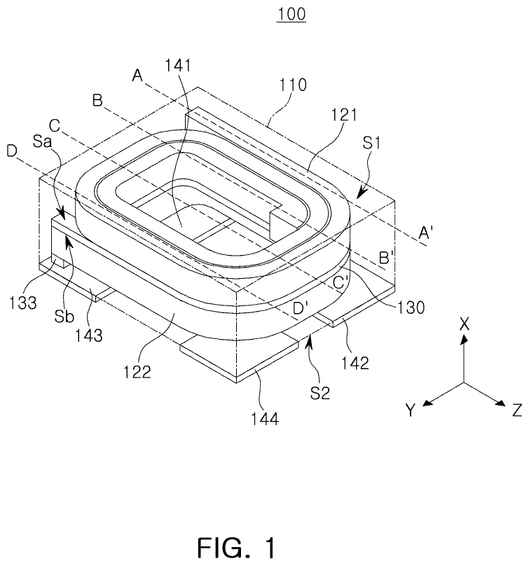

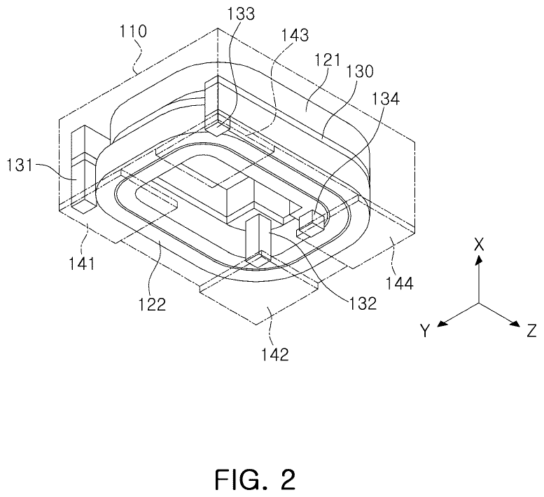

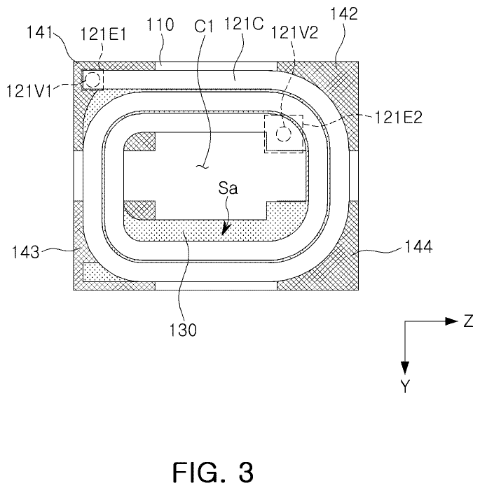

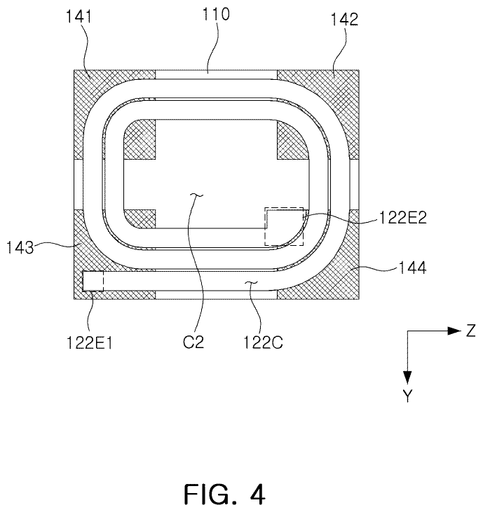

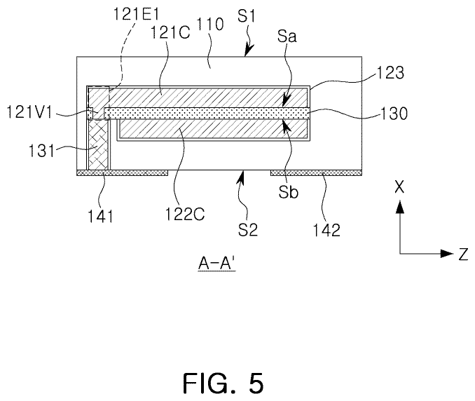

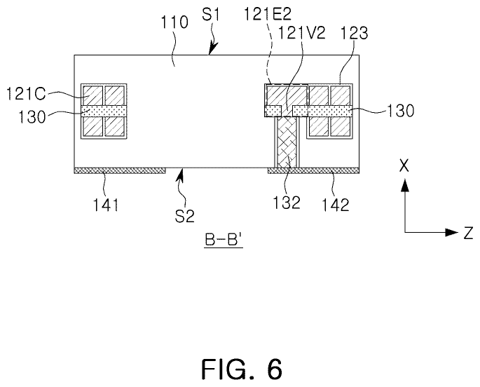

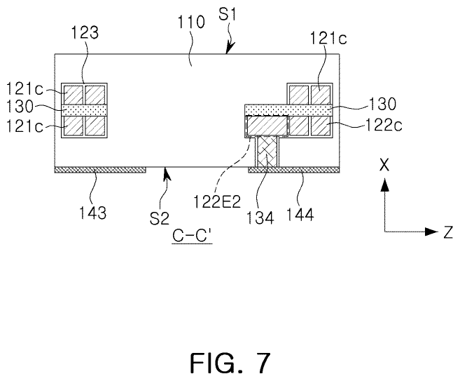

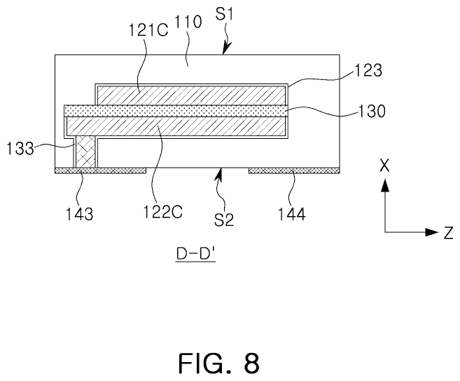

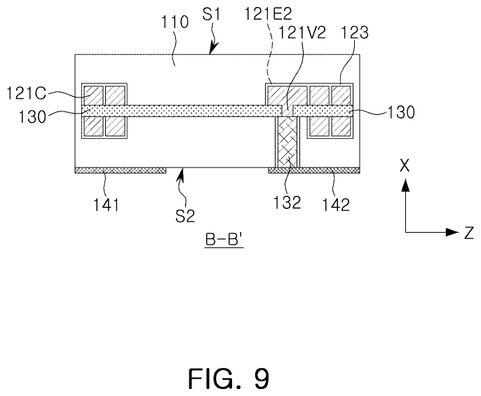

FIGS. 1 and 2 are perspective views schematically illustrating a coil component according to an embodiment. FIGS. 3 and 4 are plan views of main components of the coil component of FIG. 1 viewed from above. FIGS. 5 to 8 are cross-sectional views of regions indicated in FIG. 1. FIGS. 9 to 14 illustrate coil components according to a modified example.

Referring to FIGS. 1 and 2, a coil component 100 according to an embodiment includes a body 110, a supporting member 130, a first coil 121, a second coil 122, first to fourth connection electrodes 131-134, and first to fourth external electrodes 141-144. In the case of the present embodiment, by disposing the first and second coils 121 and 122 on one surface Sa and the other surface Sb of the supporting member 130, respectively, the degree of magnetic coupling of the first and second coils 121 and 122 may be effectively adjusted, while the size of the coil component 100 in the form of an inductor array may be reduced, which will be described in detail later. Hereinafter, the main elements constituting the coil component 100 of the present embodiment will be described.

In the body 110, the first and second coils 121 and 122 are disposed therein, and the overall appearance of the coil component 100 may be achieved. The body 110 may include a first surface S1 and a second surface S2 disposed perpendicular to a first direction (X-direction) while facing each other, and one or more side surfaces connected thereto. In this case, directions perpendicular to the first direction (X-direction) may be defined as a second direction (Y-direction) and a third direction (Z-direction), and the second direction (Y-direction) and the third direction (Z-direction) may be perpendicular to each other. Also, the first direction (X-direction) may correspond to a thickness direction of the body 110 and the supporting member 130. In the following description, the first direction (X-direction), the second direction (Y-direction), and the third direction (Z-direction) represent both directions, respectively, and for example, the first direction (X-direction) includes both an upper direction and a lower direction based on the drawing.

The body 110 may include an insulating resin and a magnetic material. In detail, the body 110 may be formed by stacking one or more magnetic composite sheets in which a magnetic material is dispersed in an insulating resin. The magnetic material may be ferrite or metallic magnetic powder. The ferrite may be at least one of, for example, spinel ferrites such as Mg—Zn, Mn—Zn, Mn—Mg, Cu—Zn, Mg—Mn—Sr, Ni—Zn, Ba—Zn, Ba—Mg, Hexagonal ferrites such as Ba—Ni, Ba—Co, and Ba—Ni—Co, Y-type garnet ferrites and Li-type ferrites. Metal magnetic powder may include at least one selected from the group consisting of iron (Fe), silicon (Si), chromium (Cr), cobalt (Co), molybdenum (Mo), aluminum (Al), niobium (Nb), copper (Cu), and nickel (Ni). For example, the metal magnetic powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder Alloy powder, Fe—Ni—Co alloy powder, Fe—Cr alloy powder, Fe—Cr—Si alloy powder, Fe—Si—Cu—Nb alloy powder, Fe—Ni—Cr alloy powder, and Fe—Cr—Al alloy powder. The magnetic metal powder may be amorphous or crystalline. For example, the magnetic metal powder may be Fe—Si—B—Cr-based amorphous alloy powder, but is not necessarily limited thereto. The ferrite and magnetic metal powder particles may each have an average diameter of about 0.1 μm to about 30 μm, but are not limited thereto. The body 110 may include two or more types of magnetic materials dispersed in resin. In this case, the different types of magnetic materials indicate that the magnetic materials dispersed in the resin are distinguished from each other by any one of average diameter, composition, crystallinity and shape. The insulating resin may include epoxy, polyimide, liquid crystal polymer, etc. alone or in combination, but the present disclosure is not limited thereto.

Regarding an example of the manufacturing method, the body 110 may be formed by a lamination method. In detail, a plurality of unit laminates for manufacturing the body 110 may be prepared and stacked on upper and lower portions of the first and second coils 121 and 122. In this case, in the unit laminate, a slurry is prepared by mixing magnetic particles such as metal and organic materials such as a thermosetting resin, a binder, and a solvent, and the slurry is coated on a carrier film with a thickness of several tens of μm by a doctor blade method. After application, drying may be performed to prepare a sheet form. Accordingly, the unit laminate may be manufactured in a form in which magnetic particles are dispersed in a thermosetting resin such as epoxy resin or polyimide.

The supporting member 130 is disposed in the body 110 and includes one surface Sa and the other surface Sb. In this case, one surface (Sa) and the other surface (Sb) oppose in the first direction (X-direction), and first and second coils 121 and 122 are respectively disposed on one surface Sa and the other surface Sb of the supporting member 130. The supporting member 130 may include, for example, a polypropylene glycol (PPG), a ferrite, or a metal-based soft magnetic material. As illustrated, a through-hole may be formed by penetrating a portion of the supporting member 130, and a material constituting the body 110 may be filled in the through-hole. However, as in the modified embodiment of FIG. 9, through-holes may not be separately formed in regions corresponding to the cores of the first and second coils 121 and 122 in the supporting member 130. The supporting member 130 may include a magnetic material, whereby magnetic permeability of the coil component 100 may be sufficiently secured and coupling coefficients of the first and second coils 121 and 122 may be effectively adjusted. The magnetic material of the supporting member 130 may include the same magnetic powder as the magnetic material of the body 110, and may also include a metal layer such as Ni as another example. The thickness of the supporting member 130 may be adjusted considering the magnetic coupling of the first and second coils 121 and 122 and may have a thickness of several μm to several tens of μm. In more detail, the thickness of the supporting member 130 may be 10 μm or more and 50 μm or less.

A detailed structure of the first coil 121 will be described with reference to FIG. 3. The first coil 121 is disposed on one surface Sa of the supporting member 130 and includes a first winding portion 121C. One end 121E1 and the other end 121E2 of the first coil 121 are connected to the first and second external electrodes 141 and 142, respectively. In this case, one end 121E1 of the first coil 121 may be an end of an outermost turn of the first winding portion 121C, and the other end 121E2 may be an end of an innermost turn of the first winding portion 121C. One end (121E1) and the other end (121E2) of the first coil 121 may not be exposed to the side surface connected to the first surface (S1) and the second surface (S2) of the body 110, and as will be described later, may extend toward the second surface S2 of the body 110 through the connection electrodes 131 and 132.

Referring to FIG. 4, the second coil 122 is disposed on the other surface Sa of the supporting member 130 and includes a second winding portion 122C, and in FIG. 4, except for the supporting member 130, the second coil 122 disposed therebelow is illustrated. One end 122E1 and the other end 122E2 of the second coil 122 are connected to the third and fourth external electrodes 141 and 142, respectively. In this case, one end 122E1 of the second coil 122 is an end of an outermost turn of the second winding portion 122C, and the other end 122E2 may be an end of an innermost turn of the second winding portion 122C. In addition, one end 122E1 and the other end 122E2 of the second coil 122 may not be exposed to the side surface connected to the first surface S1 and the second surface S2 of the body 110, and as will be described later, may extend toward the second surface S2 of the body 110 through the connection electrodes 133 and 134.

The first and second coils 121 and 122 may be implemented in the form of an inductor array and may not be electrically connected to each other within the coil component 100. Accordingly, the first and second coils 121 and 122 may only be magnetically coupled within the coil component 100. As illustrated, the winding axis of the first and second winding portions 121C and 122C may be parallel to the first direction (X-direction). In the case of this embodiment, the first and second winding portions 121C and 122C may have a single layer structure. For example, the turn of the coil in the first winding portion 121C exists only in one layer, and no additional turns may occur on the upper portion of the first winding portion 121C or on the other surface Sb side of the supporting member 130. Similarly, the turn of the coil in the second winding portion 122C is present in only one layer, and additional turns may not occur on the lower side of the second winding portion 122C or on the side of one surface Sa of the supporting member 130. In addition, at least a portion of the core C1 of the first winding portion 121C and the core C2 of the second winding portion 122C may overlap in the first direction (X-direction). According to this structure, the size of the first and second coils 121 and 122 may be reduced and a miniaturized inductor array structure may be implemented.

On the other hand, the first and second coils 121 and 122, plating patterns used in the art, such as pattern plating, anisotropic plating, and isotropic plating, may be used, and may be formed into a multilayer structure using a plurality of processes among these processes. An example of the material constituting the first and second coils 121 and 122 may include a conductive material such as copper (Cu), aluminum (Al), silver (Ag), tin (Sn), gold (Au), nickel (Ni), lead (Pb), titanium (Ti), chromium (Cr) or alloys thereof, but the present disclosure is not limited thereto.

An insulating film 123 may be formed on surfaces of the first and second coils 121 and 122. In addition, the insulating film 123 may also be formed on portions of the connection electrodes 131 to 134 and the supporting member 130. The insulating film 123 is for electrically insulating the first and second coils 121 and 122 from the body 110 and the like, and may include a known insulating material such as parylene, but is not limited thereto. As another example, the insulating film 123 may include an insulating material such as epoxy resin other than parylene. The insulating film 123 may be formed by vapor deposition, but the present disclosure is not limited thereto. As another example, the insulating film 123 may be formed by stacking an insulating film from the top and bottom and curing the same or applying and curing an insulating paste, in a state in which the first and second coils 121 and 122 are formed. On the other hand, the insulating film 123 may be omitted depending on the embodiment. For example, in the case in which the body 110 has sufficient electrical resistance at the designed operating current and voltage of the coil component 100, the insulating film 123 may be omitted.

Referring to FIGS. 5 to 8, the first and second connection electrodes 131 and 132 are disposed on the other surface Sb side of the supporting member 130, and connect one end 121E1 and the other end 121E2 of the first coil 121 to the first and second external electrodes 141 and 142, respectively. As described above, when the first coil 121 is provided in a single layer structure on one surface Sb of the supporting member 130, an effective wiring structure may be implemented through the first and second connection electrodes 131 and 132. In this case, as illustrated in FIGS. 1 and 2, the first connection electrode 131 is disposed outside of the second winding portion 122C, and the second connection electrode 132 may be disposed inside of the second winding portion 122C. Although not essential, the wiring structure by the connecting electrode may also be applied to the second coil 122. For example, the third and fourth connection electrodes 133 and 134 are disposed on the other side of the supporting member 130 to connect one end 122E1 and the other end 122E2 of the second coil 122 to the third and fourth external electrodes 143 and 144, respectively. In this case, the third connection electrode 133 may be disposed outside of the first winding portion 121C, and the fourth connection electrode 134 may be disposed inside of the first winding portion 121C.

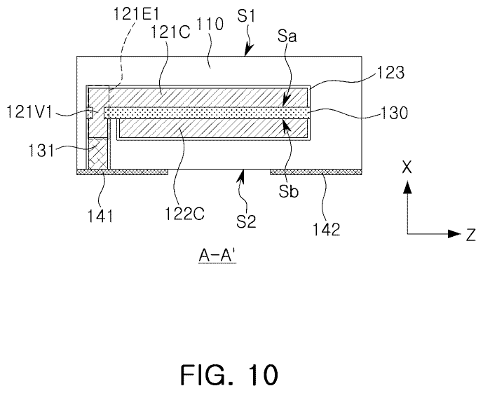

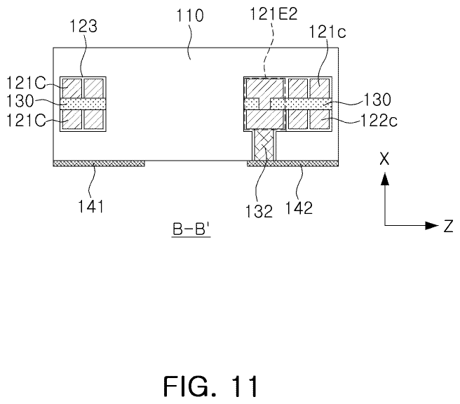

The first to fourth connection electrodes 131 to 134 may be provided in the form of metal posts, and may be, for example, copper posts. The first and second connection electrodes 131 and 132 in the form of a metal pillar structure may be bonded to one end 121E1 and the other end 121E2 of the first coil 121, respectively, and in this case, the bonding process is, for example, a thermal ultrasonic bonding process. Similarly, the third and fourth connection electrodes 133 and 134 in the form of a metal pillar structure may be bonded to one end 122E1 and the other end 122E2 of the second coil 122, respectively. In this case, the regions respectively connected to the first and second connection electrodes 131 and 132 at one end 121E1 and the other end 121E2 of the first coil 121 may be conductive vias 121V1 and 121V2 penetrating the supporting member 130. Alternatively, as in the modification example of FIGS. 10 and 11, one end 121E1 and the other end 121E2 of the first coil 121 extend to the other surface Sb of the supporting member 130, and in this case, the thickness of the region extending from one end 121E1 and the other end 121E2 of the first coil 121 to the other surface Sb of the supporting member 130 may be the same as the thickness of the second coil 122. The thicknesses may be measured by an optical microscope or a scanning electron microscope. Other methods and/or tools appreciated by one of ordinary skill in the art, even if not described in the present disclosure, may also be used.

In addition, regions extending from one end 121E1 and the other end 121E2 of the first coil 121 to the other surface Sb of the supporting member 130 may be simultaneously formed of the same material as the second coil 122.

The first and second external electrodes 141 and 142 are connected to one end 121E1 and the other end 121E2 of the first coil 121, respectively. The third and fourth external electrodes 143 and 144 are respectively connected to one end 122E1 and the other end 122E2 of the second coil 122. As illustrated, the first to fourth external electrodes 141 to 144 may be disposed on the second surface S2 of the body 110, and accordingly, the second surface S2 may be provided as a mounting surface of the coil component 100. The first to fourth external electrodes 141 to 144 may be disposed at different corners of the second surface S2, respectively. In this case, the first external electrode 141 and the fourth external electrode 144 face each other in the diagonal direction of the second surface S2, and the second external electrode 142 and the third external electrode 143 may be disposed to face each other in a diagonal direction of the second surface S2.

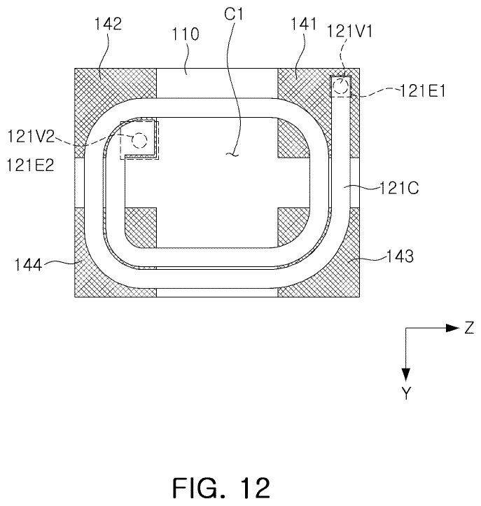

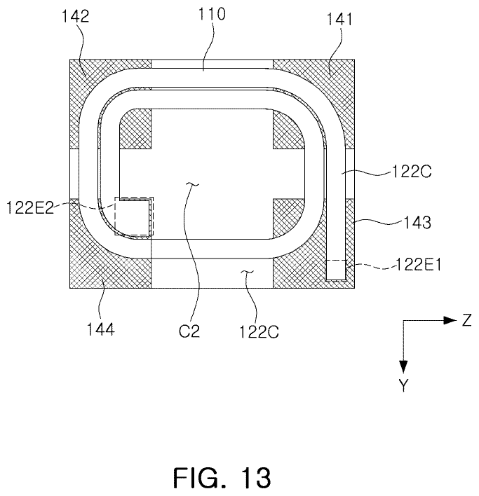

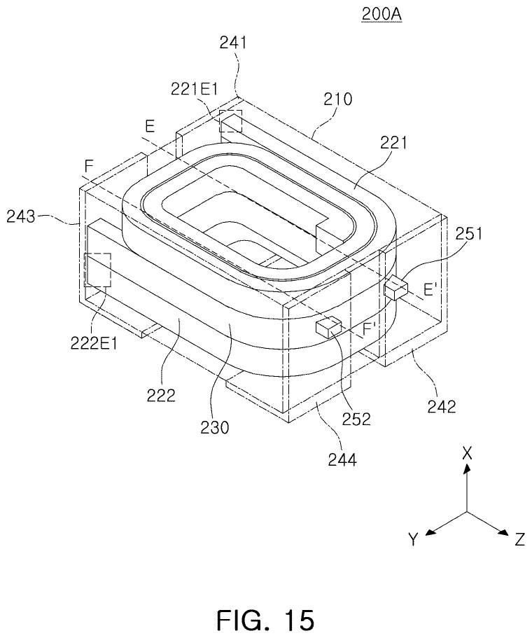

On the other hand, the arrangement method of the first and second coils 121 and 122 and the external electrodes 141 to 144 may have a structure similar to the modification of FIGS. 12 and 13. In detail, the first and second external electrodes 141 and 142 are connected to one end 121E1 and the other end 121E2 of the first coil 121, respectively, and the third and fourth external electrodes 143 and 144 are connected to one end 122E1 and the other end 122E2 of the second coil 122, respectively, and in this case, the positions of the external electrodes 141 to 144 and the ends 121E1, 121E2, 122E1, and 122E2 are different from those in the previous embodiment. The first and second external electrodes 141 and 142 may face each other in a third direction (Z-direction), and the third and fourth external electrodes 143 and 144 may face each other in a third direction (Z-direction). Also, the first and third external electrodes 141 and 143 may face each other in a second direction (Y-direction), and the second and fourth external electrodes 142 and 144 may face each other in a second direction (Z-direction). Also, the first and fourth external electrodes 141 and 144 may face each other in a diagonal direction, and the second and third external electrodes 142 and 143 may face each other in a diagonal direction. The arrangement method of the first and second coils 121 and 122 and the external electrodes 141 to 144 illustrated in FIGS. 12 and 13 may also be employed in the following embodiments of FIG. 15.

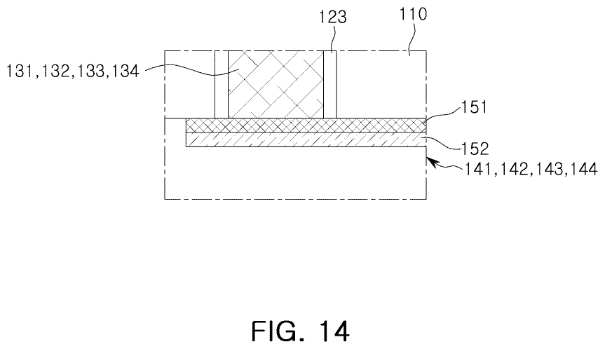

The first to fourth external electrodes 141 to 144 may be formed using a paste containing a metal having high electrical conductivity, and the paste may be a conductive paste containing, for example, nickel (Ni), copper (Cu), tin (Sn), or silver (Ag) alone or alloys thereof, or the like. Alternatively, the first to fourth external electrodes 141 to 144 may be plated layers or may be formed by directly forming a plated layer on the surfaces of the first to fourth connection electrodes 131 to 134. Also, as in the modified example of FIG. 14, the first to fourth external electrodes 141 to 144 may have a multilayer structure including a base layer 151 formed of conductive paste and a plating layer 152 covering the base layer 151. In this case, the plating layer 152 may include at least one selected from the group consisting of nickel (Ni), copper (Cu), and tin (Sn), and for example, a nickel (Ni) layer and a tin (Sn) layer may be formed sequentially.

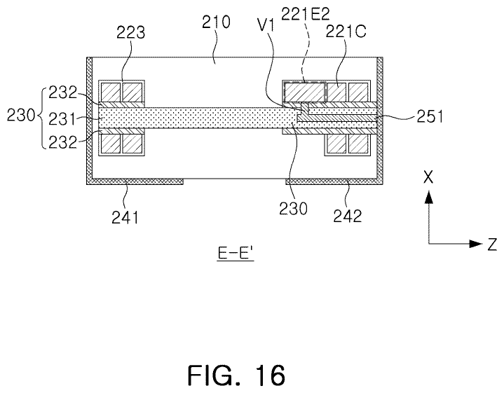

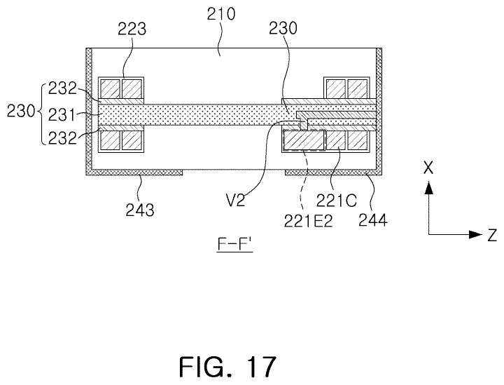

Other embodiments will be described with reference to FIGS. 15 to 19. First, in the case of the embodiment of FIGS. 15 to 17, a coil component 200A includes a body 210, a supporting member 230, a first coil 221, a second coil 222, first and second bypass electrodes 251 and 252, and first to fourth external electrodes 241 to 244. In addition, an insulating film 223 covering a portion of the surface may be provided to protect the first and second coils 221 and 222. If the description is centered on parts different from the above-described embodiment, in the present embodiment, the coils 221 and 222 and the external electrodes 241 to 244 are connected by the bypass electrodes 251 and 252, and the bypass electrodes 251 and 252 may extend to the side of the body 210. In detail, one end 221E1 of the first coil 221 is the end of the outermost turn of the first winding portion 221C, the other end 221E2 of the first coil 221 is the end of the innermost turn of the first winding portion 221C, one end 222E1 of the second coil 222 is the end of the outermost turn of the second winding portion 222C, and the other end 222E2 of the second coil 222 is the end of the innermost turn of the second winding portion 222C. In this case, the first bypass electrode 251 connects the other end 221E2 of the first coil 221 to the second external electrode 242, and may be connected to the other end 221E2 of the first coil 221 through the conductive via V1. In addition, one end 221E1 of the first coil 221 may extend to the side of the body 210 and be directly connected to the first external electrode 241. In addition, the second bypass electrode 252 connects the other end 222E2 of the second coil 222 to the fourth external electrode 242 and may be connected to the other end 222E2 of the second coil 222 through the conductive via V2. In addition, one end 222E1 of the second coil 222 may extend to the side of the body 210 and be directly connected to the third external electrode 243.

As illustrated, at least a portion of the first and second bypass electrodes 251 and 252 may overlap the first and second winding portions 221C and 222C in the first direction (X-direction). As the ends of the first and second coils 121 and 122 extend to the side of the body 210, the first to fourth external electrodes 241 to 244 may be formed on the side of the body 210, and for example, may have an L shape. The supporting member 230 may have a multilayer structure, and in detail, may include a magnetic layer 231 and insulating layers 232 and 233 disposed on one surface and the other surface thereof. The magnetic permeability may be adjusted by adjusting the thickness of the magnetic layer 231, and in this case, the magnetic layer 231 may not have a through-hole in the center. The conductive via V1 may pass through the insulating layer 232, and the first bypass electrode 251 may be disposed between the magnetic layer 231 and the insulating layer 232. Also, the conductive via V2 may pass through the insulating layer 233, and the second bypass electrode 252 may be disposed between the magnetic layer 231 and the insulating layer 233. However, the supporting member 230 may be employed as the supporting member 130 having a structure similar to the structure of the previous embodiment, rather than a multilayer structure.

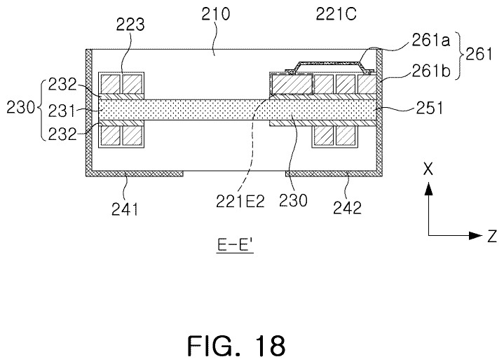

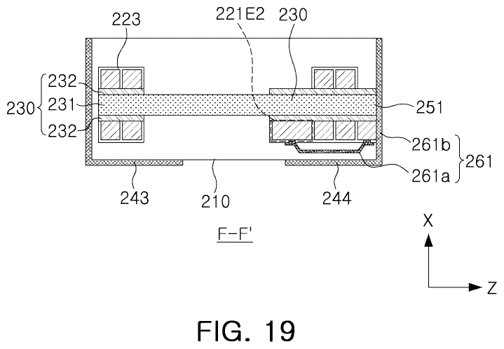

Next, in the case of the embodiment of FIGS. 18 and 19, the coil component 200B is different from the embodiment of FIGS. 15 to 17 in the shape of the bypass electrodes 261 and 262. In detail, the first and second bypass electrodes 261 and 262 are formed on the upper and lower sides of the first and second coils 221 and 222, respectively, rather than being buried in the supporting member 230. Accordingly, the first coil 221 may be disposed between the first bypass electrode 261 and the supporting member 230, and the second coil 222 may be disposed between the second bypass electrode 262 and the supporting member 230. The first and second bypass electrodes 261 and 262 may be respectively connected to the first and second coils 221 and 222 by a bonding process using ultrasonic waves or heat, and may include bent portions 261a and 262a, respectively. In addition, the first and second bypass electrodes 261 and 262 may include pattern portions 261b and 262b in regions connected to the second and fourth external electrodes 242 and 244, respectively. The pattern portions 261b and 262b may be formed of the same material and height as the material and height of the first and second coils 221 and 222, respectively. The supporting member 230 may have a multilayer structure, and in detail, may include a magnetic layer 231 and insulating layers 232 and 233 disposed on one surface and the other surface thereof. The magnetic permeability may be adjusted by adjusting the thickness of the magnetic layer 231, and in this case, the magnetic layer 231 may not have a through-hole in the center. However, the supporting member 230 may be employed as the supporting member 130 having a structure similar to the structure of the previous embodiment, rather than a multilayer structure.

As set forth above, in the case of the coil component according to an embodiment, it may be advantageous in miniaturization and the coupling coefficient between coils may be effectively adjusted.

While example embodiments have been illustrated and described above, it will be apparent to those skilled in the art that modifications and variations could be made without departing from the scope of the present disclosure as defined by the appended claims.

What is claimed is:

1. A coil component comprising:
a body;
a supporting member disposed in the body and including one surface and the other surface opposing the one surface in a first direction;
a first coil including a first winding portion disposed on the one surface of the supporting member;
a second coil including a second winding portion disposed on the other surface of the supporting member;
a first external electrode and a second external electrode connected to one end and the other end of the first coil, respectively;
a third external electrode and a fourth external electrode connected to one end and the other end of the second coil, respectively; and
a first connection electrode and a second connection electrode disposed on the other surface of the supporting member and connecting one end and the other end of the first coil to the first and second external electrodes, respectively.

2. The coil component of claim 1, wherein the first and second winding portions have a single-layer structure.

3. The coil component of claim 1, wherein at least portions of a core of the first winding portion and a core of the second winding portion overlap in the first direction.

4. The coil component of claim 1, wherein the first connection electrode is disposed outside of the second winding portion, and the second connection electrode is disposed inside of the second winding portion.

5. The coil component of claim 1, further comprising a third connection electrode and a fourth connection electrode disposed on the other surface of the supporting member and connecting one end and the other end of the second coil to the third and fourth external electrodes, respectively.

6. The coil component of claim 5, wherein the third connection electrode is disposed outside of the first winding portion, and the fourth connection electrode is disposed inside of the first winding portion.

7. The coil component of claim 1, wherein the body includes a first surface and a second surface opposing in the first direction and disposed on the one surface and the other surface of the supporting member, respectively, and the first to fourth external electrodes are disposed on the second surface.

8. The coil component of claim 7, wherein the first and second external electrodes are disposed on different corners of the second surface, respectively, the first external electrode and the fourth external electrode face each other in a diagonal direction of the second surface, and the second external electrode and the third external electrode face each other in the diagonal direction of the second surface.

9. The coil component of claim 8, wherein the one end of the first coil is an end of an outermost turn of the first winding portion, and the other end of the first coil is an end of an innermost turn of the first winding portion, and
the one end of the second coil is an end of an outermost turn of the second winding portion, and the other end of the second coil is an end of an innermost turn of the second winding portion.

10. The coil component of claim 7, wherein the one end and the other end of the first coil are not exposed to a side surface connected to the first and second surfaces in the body, and
the one end and the other end of the second coil are not exposed to a side surface connected to the first and second surfaces in the body.

11. The coil component of claim 1, wherein the one end and the other end of the first coil extend to the other surface of the supporting member, and a thickness of a region extending from each of the one end and the other end of the first coil to the other surface of the supporting member is the same as a thickness of the second coil.

12. The coil component of claim 1, wherein the first and second coils are not electrically connected to each other within the coil component.

13. The coil component of claim 1, wherein the supporting member includes a magnetic material.

14. A coil component comprising:
a body;
a supporting member disposed in the body and including one surface and the other surface opposing the one surface in a first direction;
a first coil including a first winding portion disposed on the one surface of the supporting member;
a second coil including a second winding portion disposed on the other surface of the supporting member;
a first external electrode and a second external electrode connected to one end and the other end of the first coil, respectively;
a third external electrode and a fourth external electrode connected to one end and the other end of the second coil, respectively;
a first bypass electrode connecting the other end of the first coil to the second external electrode; and
a second bypass electrode connecting the other end of the second coil to the fourth external electrode,
wherein the one end of the first coil is an end of an outermost turn of the first winding portion, and the other end of the first coil is an end of an innermost turn of the first winding portion, and
the one end of the second coil is an end of an outermost turn of the second winding portion, and the other end of the second coil is an end of an innermost turn of the second winding portion.

15. The coil component of claim 14, wherein at least portions of the first and second bypass electrodes respectively overlap the first and second winding portions in the first direction.

16. The coil component of claim 14, wherein at least portions of the first and second bypass electrodes are buried in the supporting member.

17. The coil component of claim 14, wherein the supporting member includes a magnetic layer and an insulating layer disposed on one surface and the other surface of the magnetic layer.

18. The coil component of claim 14, wherein the first coil is disposed between the first bypass electrode and the supporting member, and
the second coil is disposed between the second bypass electrode and the supporting member.

19. The coil component of claim 18, wherein the first and second bypass electrodes respectively include a bent portion.

20. A coil component comprising:
a body;
a supporting member disposed in the body and including one surface and the other surface opposing the one surface in a first direction;
a first coil including a first winding portion disposed on the one surface of the supporting member, wherein the first winding portion has a single-layer structure;
a second coil including a second winding portion disposed on the other surface of the supporting member;
a first external electrode and a second external electrode connected to one end and the other end of the first coil, respectively;
a third external electrode and a fourth external electrode connected to one end and the other end of the second coil, respectively; and
a first connection electrode and a second connection electrode disposed on the other surface of the supporting member and connecting one end and the other end of the first coil to the first and second external electrodes, respectively, wherein the first connection electrode is disposed outside of the second winding portion, and the second connection electrode is disposed inside of the second winding portion.

21. The coil component of claim 20, further comprising a third connection electrode and a fourth connection electrode disposed on the other surface of the supporting member and connecting one end and the other end of the second coil to the third and fourth external electrodes, respectively.

22. The coil component of claim 21, wherein the third connection electrode is disposed outside of the first winding portion, and the fourth connection electrode is disposed inside of the first winding portion.

23. The coil component of claim 22, wherein the body includes a first surface and a second surface opposing in the first direction and disposed on the one surface and the other surface of the supporting member, respectively, and the first to fourth external electrodes are disposed on the second surface.
